(19) United States
(12) Patent Application Publication
(10) Pub. No.: US 2016/0282496 A1
(43) Pub. Date: Sep. 29, 2016

(54) SEGMENTED-CENTRALIZED-TYPE HIGH-DENSITY ELECTRICAL METHOD MEASUREMENT SYSTEM AND APPLICATION THEREOF

(71) Applicant: ST GEOMATIVE CO., LTD., Shenzhen (CN)

(72) Inventor: Quan YUAN, Shenzhen (CN)

(73) Assignee: ST GEOMATIVE CO., LTD., Shenzhen (CN)

(21) Appl. No.: 15/025,717

(22) PCT Filed: Aug. 1, 2014
(86) PCT No.: PCT/CN2014/083494

§ 371 Date: Jun. 3, 2016

(30) Foreign Application Priority Data
Sep. 30, 2013 (CN) 201310469794.1

(51) Int. Cl. G01V 3/02

(52) U.S. Cl. CPC G01V 3/02

(57) ABSTRACT

A segmented-centralized-type high-density electrical method measurement system and use thereof including a testing host, a plurality of electrode switching devices, a plurality of cables with taps, and a plurality of electrodes connected to the taps. By using this segmented-centralized-type high-density electrical measurement system, compared with a centralized-type high-density electrical measurement system, the required cable taps are less, the required cable weight is lower, not only resistivity test can be supported, but also induced polarization test, which is not supported by the centralized-type system, can be supported, the maximum transmitting current is larger, and rolling test can be supported; compared with a distributed-type high-density electrical measurement system, the cable diameter is smaller, the maximum transmitting current is larger, the cable weight is lighter, the cables are low-cost and durable, and because the cables can be replaced individually, their maintenance cost is low.

### TECHNICAL FIELD

The present invention relates to the field of high-density electrical measurement systems, and in particular relates to a segmented-centralized-type high-density electrical method measurement system and use thereof.

### BACKGROUND OF THE INVENTION

Electrical method prospecting is a geophysical prospecting method that locates mineral deposit and studies geologic structure according to “electrical characteristic differences”, i.e. electrical properties such as electrical conductivity, electrochemical activity, electromagnetic induction characteristic and dielectric property of rocks and ores. Electrical method prospecting is classified into two categories: direct current method and alternating current method, wherein the direct current method includes resistivity method, electrical charging method, natural electrical field method, direct current induced polarization method, etc., and the alternating current method includes alternating current induced polarization method, electromagnetic method, ground electromagnetic method, radio-wave perspective method, micro-wave method, etc. High-density electrical method is developed on the basis of these ordinary electrical methods, and, compared with these ordinary electrical methods, the high-density electrical method have advantages such as low cost, high efficiency, rich information, convenient interpretation and strong prospecting capability. The high-density electrical method originally referred to the direct current high-density resistivity method, but since the direct current induced polarization method was developed from that, the related methods are now collectively named as the high-density electrical method.

As shown in FIG. 1, the high-density resistivity method is actually an array prospecting method, wherein, during field measurement, first, all the (tens of to hundreds of) electrodes are placed at test points which are uniformly distributed on test lines, then, by using an electrode switching device, according to requirements of various measuring methods, two of the electrodes are selected as transmitting electrodes for each single test, thus transmitting current are injected into ground, while at least two electrodes are used as receiving electrodes which are connected to a testing host through the electrode switching device, thus a test is performed and test results are recorded, and then, the selected location of the transmitting electrodes and receiving electrodes are automatically adjusted to perform the next test, such operation is repeated continuously until test of the whole section is completed.

The electrode switching device is an intelligent control circuit switching device that is able to automatically select electrodes according to requirements so as to achieve control of the electrode apparatuses. The electrode switching device is controlled by an electrical measuring instrument at the start point, and test signal is fed through an electrode switching box into the electrical measuring instrument where tests are performed and test results are recorded. Along with constant development of electronic technology, relatively large scale program-controlled electrode switching has become achievable with relatively small volume and weight, and its cost has been reduced to within a range suitable for large scale commercialization. However, a most critical problem of the high-density electrical measurement system is how to connect tens of or even hundreds of electrodes all to the program-controlled electrode switching device and then to the host by using hundreds of or even thousands of meters of test lines.

Currently, according to different connecting and wiring modes, high-density electrical measurement systems are classified into two categories: centralized-type high-density electrical measurement systems and distributed-type high-density electrical measurement systems.

In a centralized-type high-density electrical measurement system shown in FIG. 2, the electrode switching devices are all centralized near a testing host or even centralized within the host, and by using high-density cables with multiple cores and multiple taps, the individual electrodes are respectively connected to the electrode switching devices, wherein each core of the high-density cable is connected to one tap which is connected to one electrode, so as to achieve connections between the electrodes and the electrode switching devices. Because each electrode is connected by an individual core to the electrode switching device, therefore, the sum of the cores must be more than or at least equal to the sum of the electrodes, with the core length being the distance between the electrode and the electrode switching device. In consideration of transport and movement, the sum of the cores in a high-density cable is usually in a range of 25 to 30, and the sum of the taps (corresponding to the sum of the electrodes that can be connected in) is also in a range of 25 to 30, while the total length of a high-density cable does not exceed 300 m, so as to keep the weight of a single high-density cable within 30 kg. When the test lines are long and the sum of the electrodes exceeds 50-60 due to a relatively large measurement scale, the sum and weight of the cables would become very huge. As shown in FIG. 3, taking a mainstream cable with 30 taps and a tap interval of 10 m on the market as an example: when the section length is 300 m, 1 cable is required and the total cable length is 300 m; when the section length is 900 m, 3 cables are required and the total cable length is 1200 m; when the section length is 1800 m, 6 cable is required and the total cable length is 3600 m. Thus it can be seen that, as the measured section gets longer, the sum of the cables gets larger, and the total cable length would have a more significant increase. Therefore, the centralized-type high-density electrical measurement system is not suitable for a relatively long section.

When conducting resistivity test, the transmitting electrodes and the receiving electrodes have the same characteristic, i.e. both being ordinary electrodes, so the transmitting circuit and the receiving circuit can use a common cable core and electrode. When conducting high-density induced polarization test, the transmitting electrodes have a different characteristic from that of the receiving electrodes, i.e. the transmitting electrodes are ordinary electrodes, but the receiving electrodes are non-polarizable electrodes, therefore, two types of electrodes must be simultaneously connected to each tap, which means each tap has to use two cable cores, so that the sum of the cable cores needs to be doubled. Because when using a centralized-type high-density electrical measurement system to conduct high-density induced polarization test a lot of cables need to be used, high-density induced polarization test is not supported by the centralized-type high-density electrical measurement system currently on the market.

As shown in FIG. 4, high-density electrical test often uses a rolling manner, so as to measure a section that is as long as possible with a limited sum of cables. In order to simplify operation arrangement and increase test efficiency, usually not all of the cables are moved, instead only the cable at one end is moved to the other end for rearrangement of measurement. Therefore, the length of a single cable determines the minimal step length of the rolling test. FIG. 4 shows schematic diagrams of rolling tests of a distributed-type high-density electrical measurement system (the upper part) and a centralized-type high-density electrical measurement system (the lower part). As can be seen from the schematic diagrams, for a centralized-type high-density electrical measurement system, because the sum of cables are less and a single cable has more taps, the step length of rolling for each time is so long that a large blind area exists in the section measured by the rolling test and that the measuring depth is very shallow, which renders such a rolling test meaningless in engineering.

In a distributed-type high-density electrical measurement system, cable cores required by the transmitting circuit and the receiving circuit are arranged as bus cores in the high-density cable and are arranged across all the taps, meanwhile a switching circuit is embedded in each tap for switching and connecting the tap that is conductively connected to an electrode onto the transmitting circuit, the receiving circuit or a non-occupied circuit. Such taps with intelligent electrode switching capability are distributed in sequence on the cable, so that a testing host can identify each of the individual taps and allocate an address thereto according to a sequence from proximal to distal. By using the distributed-type high-density electrical measurement system, it is only required to provide a transmitting cable core, a receiving cable core, a communication cable core for controlling the operation of the intelligent taps, and a power supply cable core, all of which are arranged across all the electrodes, so that the cable length is directly proportional to the length of the test line. Compared with the centralized-type high-density electrical measurement system, the length of the distributed-type cable is reduced significantly, and therefore the distributed-type high-density electrical measurement system has very notable advantage when performing a test of ultra-long section.

However, the intelligent high-density cable used by the distributed-type high-density electrical measurement system requires a switching circuit to be integrated within each tap. To meet the requirements of dust-proof and water-proof, the taps have very complicated structure design, completely depend on manual operation to be produced, and thus have very high cost. Besides, as its working environment is in the wilderness where the working conditions are harsh, plus that the cable is inevitably dragged, twisted and roughed during practical measurement operations, therefore, the failure rate of the cable is very high, especially the fixing part between the cable and the tap sheath often malfunctions, causing that the circuit line inside the tap becomes wrung apart when twisting the cable. As for an intelligent high-density cable most common on the market, 10 taps are integrated on one cable, thus, when any one of the taps malfunctions, the whole cable becomes unusable and has to be replaced entirely, plus that the cable is used on the earth surface in the wilderness for a long time, the aging rate of the cable itself is relatively fast, circumstances such as that the outer sheath is worn through by gravel and that the cable line is torn apart by thorns and rocks happen from time to time, therefore, the service life of the cable is relatively short.

In conclusion, the centralized-type high-density electrical measurement system centralizes the electrode switching devices in one or a few boxes, while its cables have simple structure and are suitable for large scale manufacture, with advantages such as low cost and convenient maintenance. But, because the sum, volume and weight of its cables are very large and the entire device is very cumbersome, the centralized-type high-density electrical measurement system is not suitable for measurement of long section and deep portion, and not applicable to high-density induced polarization test or rolling test, thus having limited application scope. On the other hand, the biggest disadvantage of the distributed-type high-density electrical measurement system is that its intelligent distributed cable has very expensive production cost and limited service life, and if a cable needs to be replaced, the user has to bear very high cost. Besides, because the tap space of an intelligent cable is limited, the battery and power supply cannot be designed freely, and the system can only depend on a working power supply bus line to provide working power from the measuring instrument. When a tap is very far from the instrument, there would be very large line resistance on the power supply bus line, causing very large voltage drop of the working power source and rendering it unable to drive the tap circuit. Therefore, the distributed-type high-density electrical measurement system has to provide a relay battery apparatus within every prescribed distance for raising the working voltage.

### SUMMARY OF THE INVENTION

In consideration of the limited prospecting range and function of the centralized-type high-density electrical measurement system as well as the defects such as high production cost and difficult maintenance of the distributed-type high-density electrical measurement system, the present invention provides a segmented-centralized-type high-density electrical method measurement system that requires less cable taps and lighter cable weight, not only supports resistivity test but also supports induced polarization test which is not supported by the centralized-type system, with the maximum transmitting current being larger, and also supports rolling test; wherein the cable diameter is smaller, the maximum transmitting current is larger, the cable weight is lighter, the cables are low-cost and durable, and because the cables can be replaced individually, their maintenance cost is low.

The technical solution provided by the present invention is as follows:

A segmented-centralized-type high-density electrical method measurement system comprises a testing host, a plurality of electrode switching devices, a plurality of cables with taps, and a plurality of electrodes connected to the taps, wherein, the testing host is connected in series to the electrode switching devices by means of the cables, and the electrode switching devices are connected to one another in series by means of the cables, the cables have a plurality of cable cores arranged therein, and the cable cores comprises a bus core and tapped cores connected to the taps.

Preferably, the electrode switching device comprises a switching circuit and a control circuit, and the control circuit is adapted for performing communication and conducting power source management.

Preferably, the cable has 7-15 taps.

More preferably, the cable has 10-12 taps.

Preferably, the bus core comprises a transmitting circuit, a receiving circuit, a communication control circuit, and/or a power supply circuit.

Preferably, the communication control circuit is adapted for communicating with the testing host, receiving a command from the testing host and sending feedback status information, and driving the switching circuit to perform switching among the electrodes according to the command from the testing host.

Preferably, the switching circuit connects the transmitting circuit and the receiving circuit, both of which are used for testing, to the tapped cores.

Furthermore, the tapped core is cut into a first thread end at a front position and a second thread end at a rear position, the corresponding tap is cut to form a first signal contact point connected to the first thread end and a second signal contact point connected to the second thread end, another identical switching circuit is added into the electrode switching device, and the tapped core is switched to be connected to the transmitting circuit and the receiving circuit of the bus core by means of the electrode switching device.

Furthermore, a part of reserved cores in the bus core are connected in parallel to form a transmitting circuit, thereby increasing large current capacity of the cables.

The beneficial technical effects of the present invention are illustrated as follows:

A particular product GD10 (with 12 taps for instance) implemented in accordance with the present invention is compared with two most typical products currently on the market.

TABLE 1
Comparison of a segmented-centralized-type high-density electrical measurement system with a
centralized-type and a distributed-type high-density electrical measurement system

| Comparison | | | | |
|---|---|---|---|---|
| subject | segmented-centralized-type | centralized-type | distributed-type | |
| model type | GD10 | BTSK | BTSK | AGI-R8 |
| sum of cable taps | 12 | 30 | 10 | 4 |
| cable diameter | 7.8 mm | 7.0 mm | 8.0 mm | 12.0 mm |
| unit cable weight | 12 kg, including the | 30 kg, excluding | 15 kg, including | 4 kg, including |
| | electrode switching devices | the electrode | the electrode | the electrode |
| | | switching devices | switching devices | switching devices |
| function | resistivity test + | resistivity test | resistivity test + | resistivity test + |
| | induced polarization test | | induced | induced |
| | | | polarization test | polarization test |
| maximum | 4A | 2A | 2.5A | 2A |
| transmitting | | | | |
| current | | | | |
| configuration of | 60 kg | 60 kg | 90 kg | 60 kg |
| 60 electrodes | | | | |
| configuration of | 90 kg | 120 kg | 135 kg | 90 kg |
| 90 electrodes | | | | |
| configuration of | 120 kg | 180 kg | 180 kg | 120 kg |
| 120 electrodes | | | | |
| configuration of | 180 kg | 360 kg | 270 kg | 180 kg |
| 180 electrodes | | | | |
| configuration of | 240 kg | 600 kg | 360 kg | 240 kg |
| 240 electrodes | | | | |

As known from Table 1, by using the segmented-centralized-type high-density electrical measurement system, compared with the centralized-type high-density electrical measurement system, the required cable taps are less, the required cable weight is lower, not only resistivity test can be supported, but also induced polarization test, which is not supported by the centralized-type system, can be supported, the maximum transmitting current is larger, and rolling test can be supported; compared with a distributed-type high-density electrical measurement system, the cable diameter is smaller, the maximum transmitting current is larger, the cable weight is lighter, the cables are low-cost and durable, and because the cables can be replaced individually, their maintenance cost is low.

### BRIEF DESCRIPTION OF THE DRAWINGS

FIG. 1 is a schematic diagram of a high-density electrical measurement system;

FIG. 2 is a schematic diagram of cables of a centralized-type high-density electrical measurement system;

FIG. 3 is a schematic diagram of the system configuration and required cables of a centralized-type high-density electrical measurement system;

FIG. 4 is a schematic diagram of the principle of rolling test with an illustrated rolling test by a centralized system;

FIG. 5 is a system schematic diagram of a segmented-centralized-type high-density electrical measurement system of the present invention;

FIG. 6 shows a bi-directional switching arrangement of segmented-centralized-type cables;

FIG. 7 shows cores connected in parallel of a segmented-centralized-type cable.

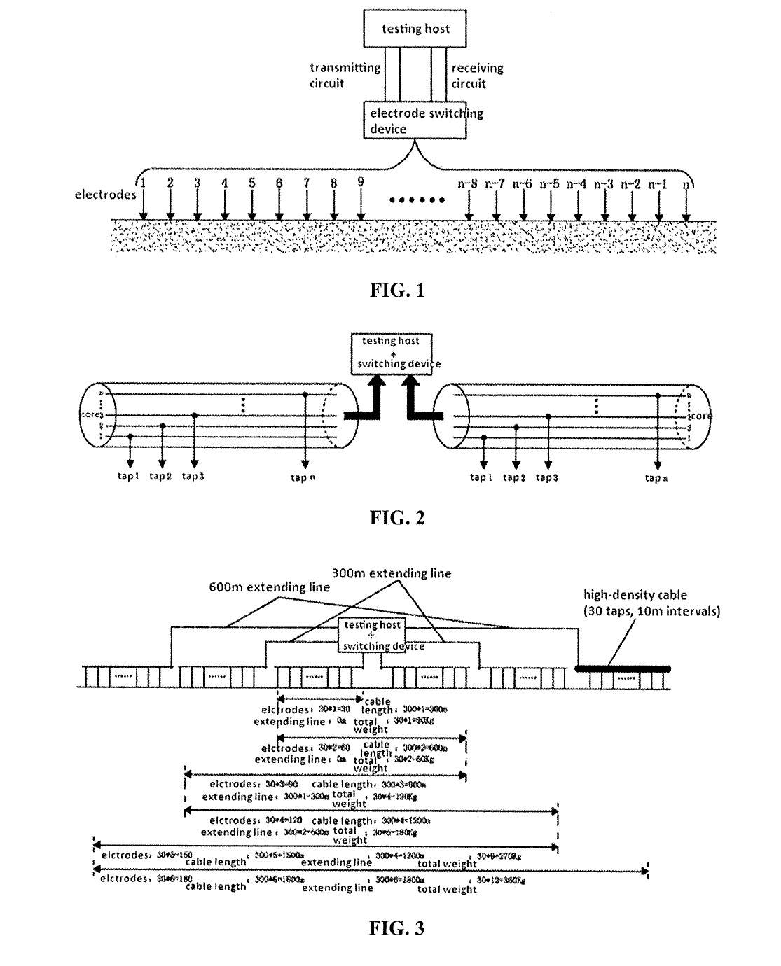

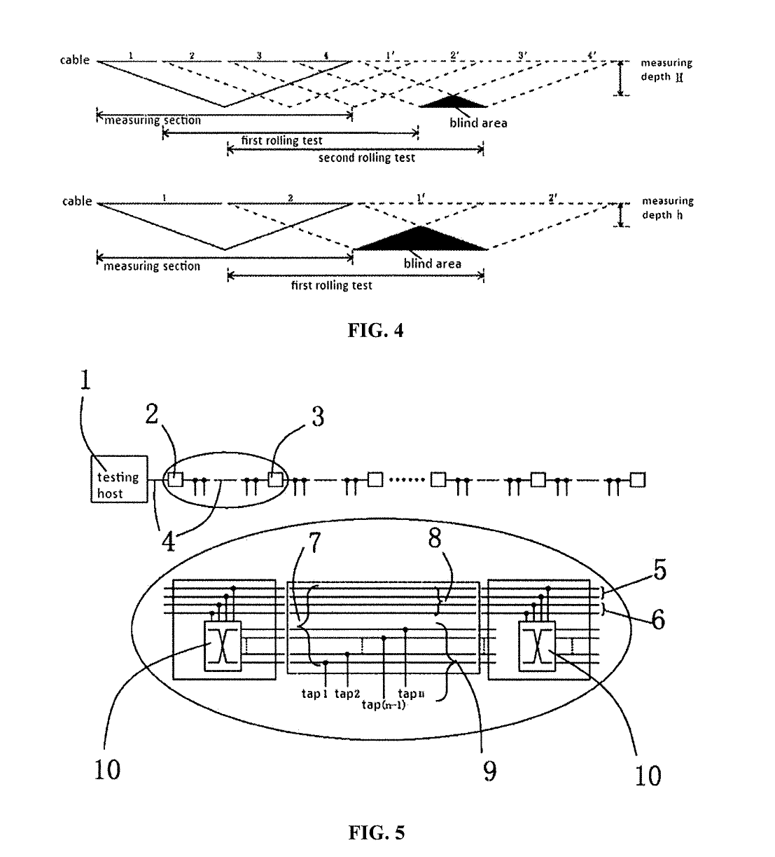

### DETAILED DESCRIPTION OF EMBODIMENTS

In order to better describe the present invention, hereinafter further description is provided in combination with specific embodiments and appended drawings.

### Embodiment 1

As shown in FIG. 5, a segmented-centralized-type high-density electrical measurement system comprises a testing host 1, a plurality of electrode switching devices (2, 3), a plurality of cables 4 with taps, and a plurality of electrodes connected to the taps, wherein, the testing host 1 is connected in series to the electrode switching devices 2 by means of the cables, and the electrode switching devices (2, 3) are connected to one another in series by means of the cables, the cables have a plurality of cable cores 7 arranged therein, and the cable cores 7 comprises a bus core 8 and tapped cores 9 connected to the taps. The electrode switching devices (2, 3) all comprises a switching circuit 10 and a control circuit, and the control circuit is adapted for performing communication and conducting power source management. The cable has 7-15 taps, preferably 10-12 taps. The bus core 8 comprises a transmitting circuit 5, a receiving circuit 6, a communication control circuit, and/or a power supply circuit, wherein the power supply circuit is optional. When the electrode switching device 2 is embedded with a working battery, the power supply circuit is not required; otherwise, when the electrode switching device 2 is supplied with power by the testing host 1, the power supply circuit is required. The communication control circuit is adapted for communicating with the testing host 1, receiving a command from the testing host 1 and sending feedback status information, and driving the switching circuit to perform switching among the electrodes according to the command from the testing host 1. The switching circuit connects the transmitting circuit 5 and the receiving circuit 6, both of which are used for testing, to the tapped cores 9.

### Embodiment 2

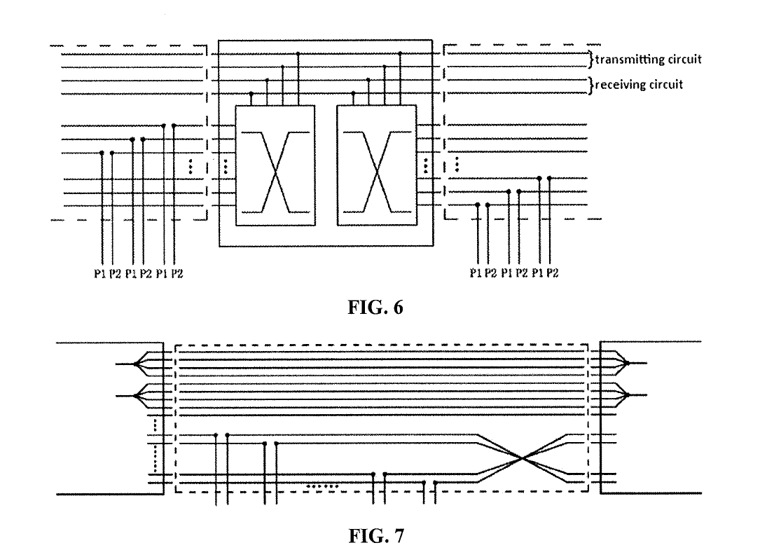

As shown in FIG. 6, a segmented-centralized-type high-density electrical measurement system is used to perform high-density induced polarization test. The tapped core 9 is cut into a first thread end and a second thread end, and the corresponding tap is cut to form a first signal contact point P1 connected to the first thread end and a second signal contact point P2 connected to the second thread end, wherein P1 represents the point at a front position and P2 represents the point at a rear position. Another identical switching circuit is added into the electrode switching device 2. The tapped core is switched to be connected to the transmitting circuit 5 and the receiving circuit 6 of the bus core 8 by means of the electrode switching device 2. Such a connection arrangement connects the first signal contact point P1 to a electrode switching device 2 at a front side and connects the second signal contact point P2 to a electrode switching device 2 at a rear side.

By adding another identical switching circuit into the electrode switching device 2, the cable core connected into the device from the front side cable is also switched to be connected to the transmitting circuit 5 and the receiving circuit 6 of the bus core 8. When an induced polarization test needs to be performed, the transmitting electrodes can be connected onto P1, and the receiving electrodes can be connected onto P2. When the testing host 1 needs to select an electrode as a transmitting electrode, the electrode switching device 2 on the front side of the particular electrode will switch the electrode to be connected to the transmitting circuit 5. When the testing host 1 needs to select an electrode as a receiving electrode, the electrode switching device 3 on the rear side of the particular electrode will switch the electrode to be connected to the receiving circuit 6. Thereby, without adding to the cores and cables, the requirements of the high-density induced polarization test are fulfilled.

In addition, the quality and measuring depth of measuring signal in an electrical test depends on the magnitude of the transmitting current to a large extent, and the magnitude of the transmitting current depends on the cable diameter. In a centralized-type arrangement, in order to reduce the cable weight, only those cables with a small diameter can be used, therefore the transmitting current is usually limited and has no room for increase, unless using cables with a large diameter which inevitably increases the cable weight. By using the bi-directional switching technology of the present embodiment, when a large current is required, P1 and P2 can be connected in series and then connected to the transmitting electrode, and during operation, both electrode switching devices (2, 3) on the front side and on the rear side can simultaneously switch the transmitting electrode to be connected to the transmitting circuit 5, thereby, without modifying the size of the cable cores, the current bearing capacity is doubled.

### Embodiment 3

As shown in FIG. 7, a segmented-centralized-type high-density electrical measurement system is used to perform large current test. The transmitting circuits 5 in the bus core 8 are connected in parallel. In a practical test, the transmitting circuit 5 needs to continuously carry the transmitting current, while any one of the taps is used as the transmitting electrode for very few times, i.e. their load ratio during actual operation are far less than the bus line transmitting circuit 5. Therefore, when considering the current bearing capacity, the core diameter that is connected to active taps of the cable may merely be ⅓-¼ of that of the bus line transmitting circuit. Due to this, when determining the cable diameter according to the maximum transmitting current, the core diameter connected to active taps (the sum of such cores account for a majority in the cable) can be reduced, so that the diameter of the transmitting bus line can be increased. For convenient manufacture and processing, cables with multiple cores of the same configuration can also be used, while a certain number of bus line cores may be reserved so as to be connected in parallel by the electrode switching device 2, thereby achieving the purpose of increasing the current bearing capacity. By using such a technique to increase the diameter of the transmitting circuit bus line, not only the transmitting current bearing capacity is increased, but also the line resistance on the transmitting circuit is effectively reduced, so that more current can be involved in the testing transmission to improve measuring efficiency and data quality.

1. A segmented-centralized-type high-density electrical method measurement system, characterized in comprising
a testing host,
a plurality of electrode switching devices,
a plurality of cables with taps, and
a plurality of electrodes connected to the taps,
wherein, the testing host is connected in series to the electrode switching devices by means of the cables, and the electrode switching devices are connected to one another in series by means of the cables, the cables have a plurality of cable cores arranged therein, and the cable cores comprises a bus core and tapped cores connected to the taps.

2. The segmented-centralized-type high-density electrical method measurement system in accordance with claim 1, characterized in that, the electrode switching device comprises a switching circuit and a control circuit, and the control circuit is adapted for performing communication and conducting power source management.

3. The segmented-centralized-type high-density electrical method measurement system in accordance with claim 1, characterized in comprising 7-15 taps.

4. The segmented-centralized-type high-density electrical method measurement system in accordance with claims 1 and 3, characterized in comprising 10-12 taps.

5. The segmented-centralized-type high-density electrical method measurement system in accordance with claim 1, characterized in that, the bus core comprises a transmitting circuit, a receiving circuit, a communication control circuit, and/or a power supply circuit.

6. The segmented-centralized-type high-density electrical method measurement system in accordance with claims 1 and 2 and 5, characterized in that, the communication control circuit is adapted for communicating with the testing host, receiving a command from the testing host and sending feedback status information, and driving the switching circuit to perform switching among the electrodes according to the command from the testing host.

7. The segmented-centralized-type high-density electrical method measurement system in accordance with claims 1 and 5, characterized in that, the switching circuit connects the transmitting circuit and the receiving circuit, both of which are used for testing, to the tapped cores.

8. A use of the segmented-centralized-type high-density electrical method measurement system in accordance with claim 1 in induced polarization high-density test, characterized in that, the tapped core is cut into a first thread end at a front position and a second thread end at a rear position, the corresponding tap is cut to form a first signal contact point connected to the first thread end and a second signal contact point connected to the second thread end, another identical switching circuit is added into the electrode switching device, and the tapped core is switched to be connected to the transmitting circuit and the receiving circuit of the bus core by means of the electrode switching device.

9. A use of the segmented-centralized-type high-density electrical method measurement system in accordance with claim 1 in large current test, characterized in that, a part of reserved cores in the bus core are connected in parallel to form a transmitting circuit, thereby increasing large current capacity of the cables.
